(19) United States
(12) Patent Application Publication
(10) Pub. No.: US 2004/0187932 A1
(43) Pub. Date: Sep. 30, 2004

(54) TIMER FOR A GAS STOVE

(76) Inventor: Chang-Feng Chuang, Chai Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/395,131

(22) Filed: Mar. 25, 2003

(51) Int. Cl. F16K 37/00

(52) U.S. Cl. 137/552.7

(57) ABSTRACT

A timer for a gas stove comprises a pipe, a linking rod, a plunger and a timer, wherein the linking rod is inserted into the pipe and is activated by the timer. When the timer is on, the linking rod is pushed downward, and an exhale and an inhale of the pipe are in an open status for gas to flow therethrough. When the timer is off, the exhale and the inhale are closed, thus gas is blocked from flowing within the pipe.

### FIELD OF THE INVENTION

This invention relates to a timer for a gas stove, and more particularly, to a timer controls a gas output for safety reason.

### BACKGROUND OF THE INVENTION

Gas has long being used by users for its convenience, in particular to those who need to work in the kitchen. The large amount of fire assists cookers to prepare food in a short period of time.

However, users have to watch out for the gas switch either leaking or they forget to turn the switch off after, a disaster may happen easily.

In order to use the convenient stove and avoid accident happening, the present inventor has invented the present invention to provide a safe gas control.

### SUMMARY OF THE INVENTION

It is the primary object of the present invention to provide a timer for a gas stove, which is safe and easy to operate.

It is another object of the present invention to provide a timer for a gas stove, which has a low cost of manufacture and is compatible to any gas stove.

It is a further object of the present invention to provide a timer for a gas stove, which saves energy and time for users.

### BRIEF DESCRIPTION OF THE DRAWINGS

FIG. 1 is an exploded view of the present invention;

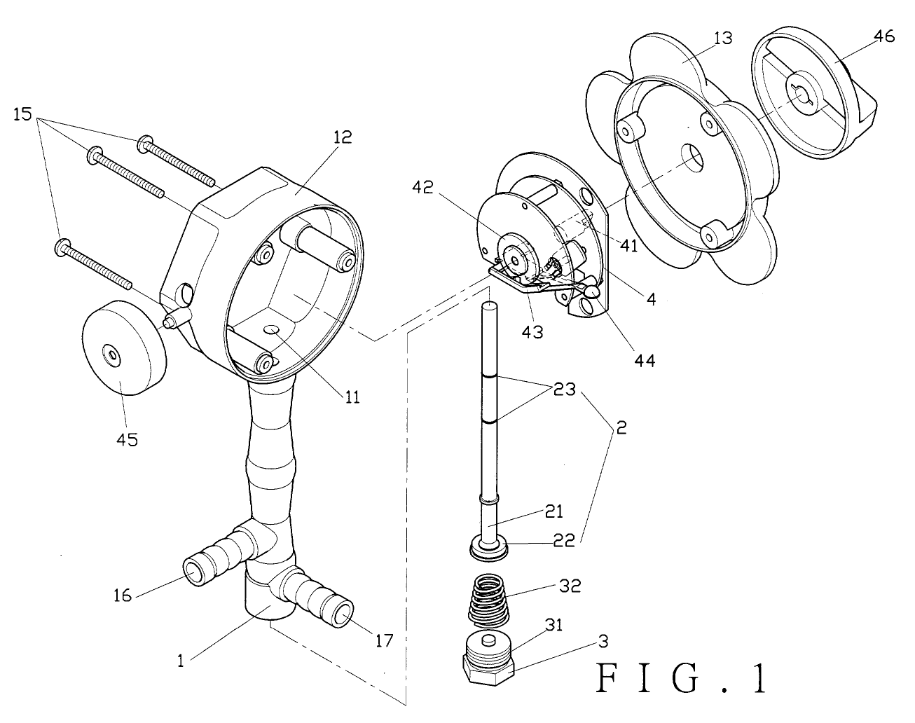

FIG. 2 is a front view of the present invention in cross section;

FIG. 3 is a view similar to FIG. 2, with the gas valve in an open position;

FIG. 4 is a view similar to FIG. 2 with the gas valve in a closed position;

FIG. 5 is a perspective view of a gas stove equipped with the present invention;

FIG. 6 is a perspective view showing a second connection method of the present invention, and

FIG. 7 is a front view showing a third connection method of the present invention.

### DETAILED DESCRIPTION OF THE PREFERRED EMBODIMENT

The present invention comprises a pipe 1, a linking rod 2, a plunger 3 and a timer 4.

The pipe 1 comprises a vertical trough 11 therein with a box 12 on the top and a compartment 14 at the bottom thereof with female threads 18 therein. The box 12 is adapted to receive the timer 4 therein and covered with a lid 13 and a knob 46. The box 12 is then secured with fasteners 15. The lower portion of the trough 11 immediate above the compartment 14 transversely extends an exhale 16 while further down the trough 11 there is a transverse inhale 17 interconnecting with the compartment 14. There is a ridge 19 between the trough 11 and the compartment 14, underneath the exhale 16 and above the inhale 17.

The linking rod 2 is placed in the trough 11 and comprises an enlarged section 21 at one end with a release valve 22 at the very endmost, O-rings 23 are placed immediate above the enlarged section 21 to seal the trough 11 from leaking when the linking rod 2 is moving up and down within the trough 11.

The plunger 3 comprises male threads 31 at the upper end and a spring 32 at the top thereof. The plunger 3 is threaded to the compartment 14.

The timer 4 is secured on the top end of the pipe 1 having an axle 41 therein and secured with the knob 46 outwardly. The axle 41 is connected to a gear set and a spiral spring (not shown) and controlled by the knob 46. The gear set links a cam 42 to activate a spring plate 43 and a spring gable 44 which is placed in a bell 45. When the timer 4 is on, the cam 42 pushes the spring plate 43 downward, and the spring plate 43 remains steady when the timer 4 is in off status.

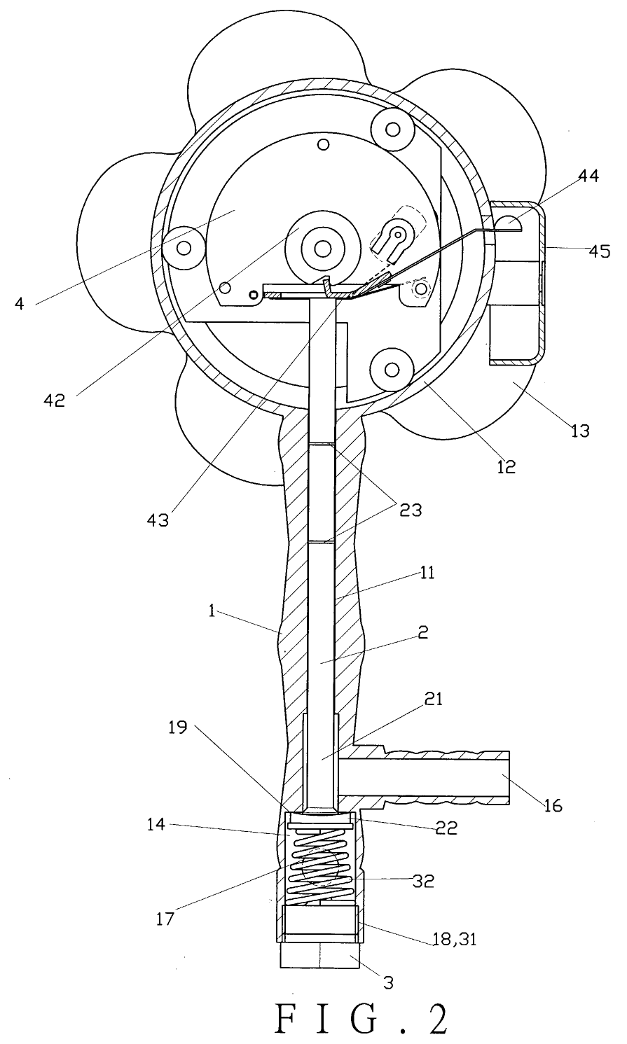

To operate the present invention, as shown in FIG. 2, the enlarged section 21 of the linking rod 2 is urged by the spring 32 to move upward within the trough 11 of the pipe 1, and the release valve 22 engages with the ridge 19 between the trough 11 and the compartment 14 to isolate the air passage between the exhale 16 and the inhale 17.

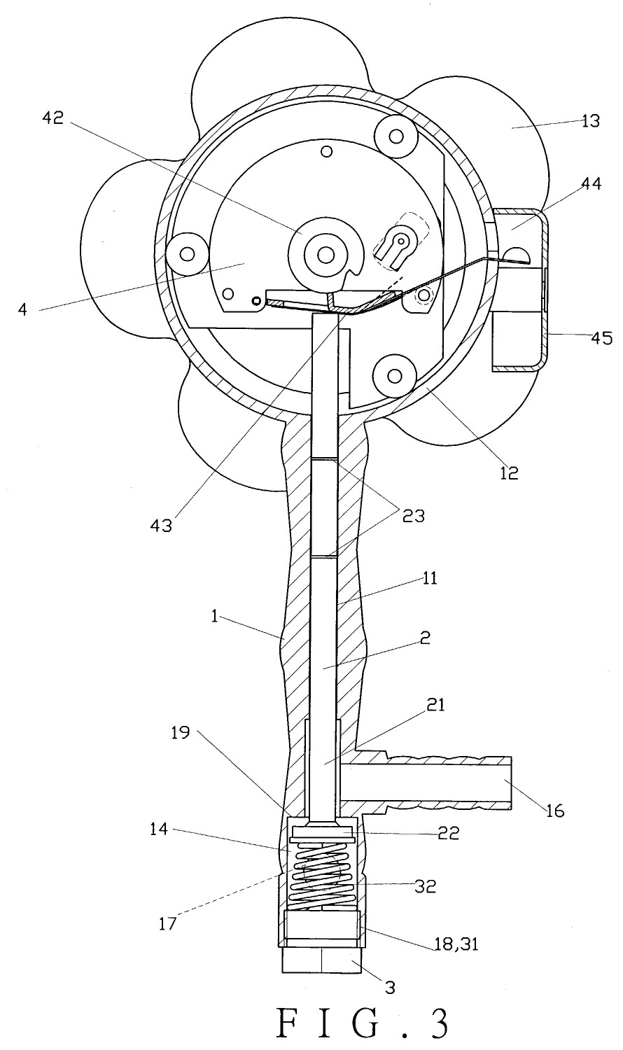

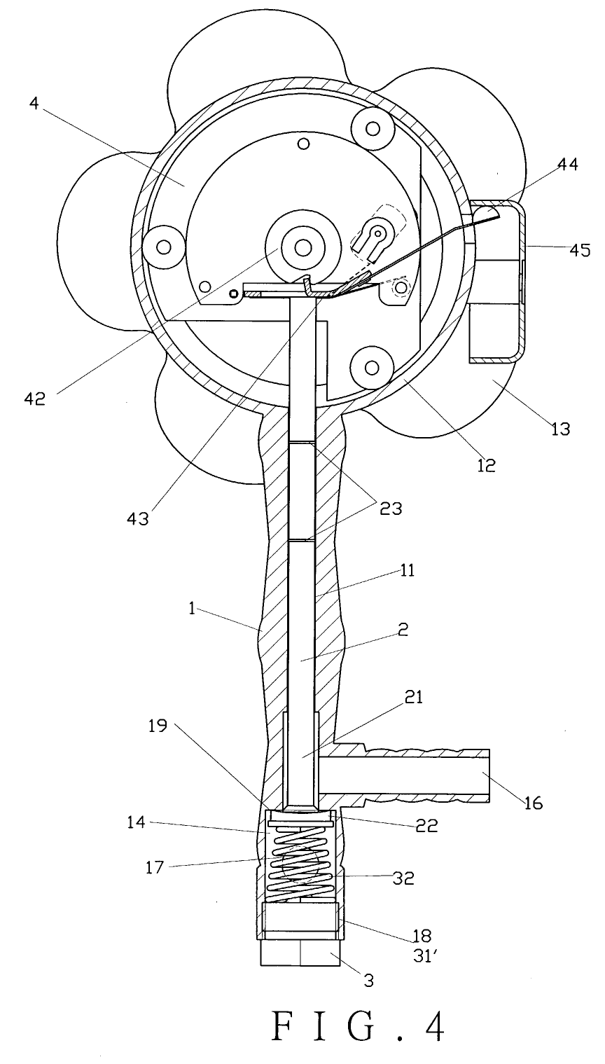

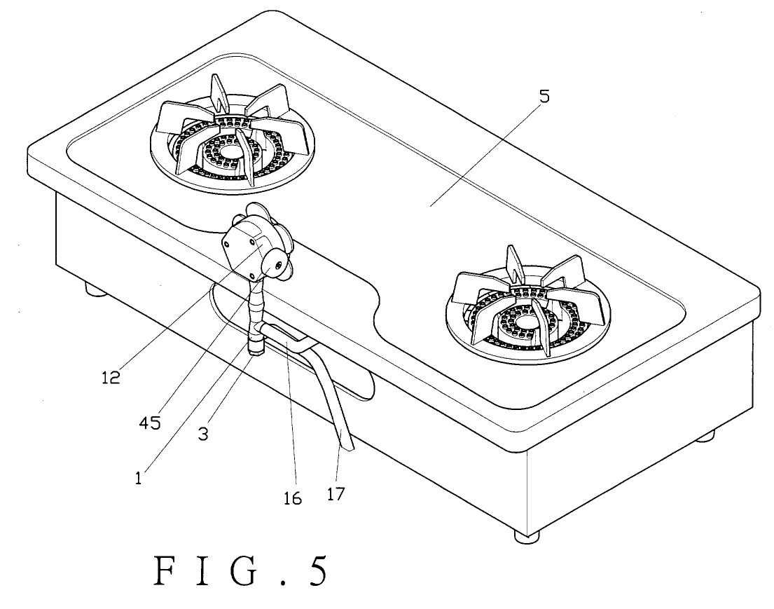

As shown in FIG. 5, the inhale 17 of the pipe 1 is connected to a gas tank while the exhale. 16 to a gas stove 5, and then the pipe 1 is secured in the middle of the stove 5 with the height of the timer 4 a little bit higher than that of the stove 5, that is easy to read and to operate. To set the timer, as shown in FIG. 3, the knob 46 is turned to a desired position, which brings the axle 41 and the cam 42 to turn in sequence, and the spring plate 43 is urged by the cam 42 to move downward and press the linking rod 2 to move downward, too. This forces the release valve 22 to detach from the ridge 19, thus the exhale 16 and the inhale 17 are in an open status. The enlarged section 21 presses the spring 32 downward, so that gas may come in from the gas tank through the inhale 17, the bride 19, and the exhale 16 into the stove 5. When the timer 4 reaches an off position, as shown in FIG. 4, the cam 42 releases the spring plate 43 to return to its original position, and the linking rod 2 is urged by the spring 32 to move upwardly and back to its original position as well, which brings the release valve 22 to engage with the ridge 19, thus the passage for gas to flow through is blocked again.

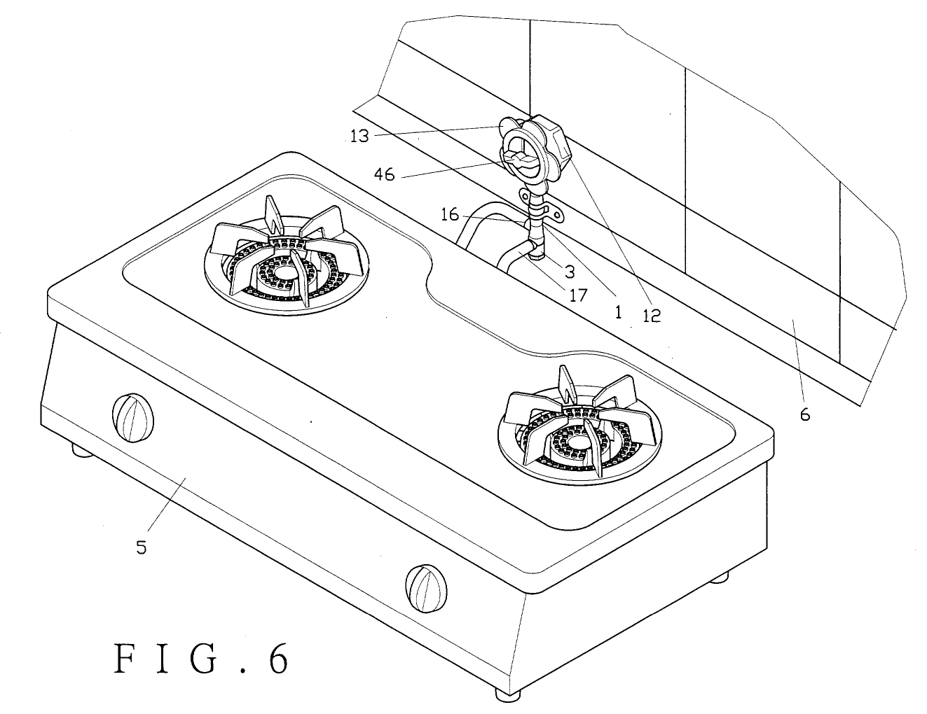

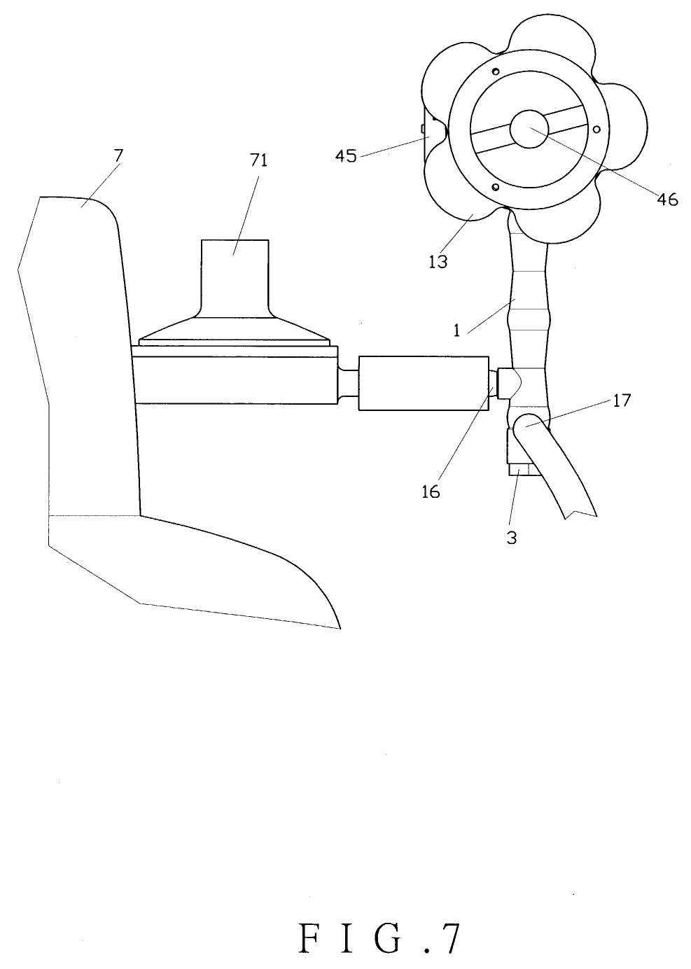

FIGS. 6 and 7 show different connection methods. As shown in FIG. 6, the pipe 1 is secured to a wall 6 and connected to a gas pipe which the gas source comes from the gas company directly. As shown in FIG. 7, the pipe 1 is connected to a gas adjustor 71 on a gas tank 7.

I claim:

1. A timer for a gas stove comprising a pipe, a linking rod, a plunger and a timer, wherein said timer being secured to a top end of said pipe, said timer comprising an axle having an end connected to a knob and another end connected to a gear set and a spiral spring within said timer, said gear set linking a cam, a spring plate and a spring gable sequentially, and said spring gable located in a bell, and being characterized that,
said pipe comprising a vertical trough with a box connected to a top end adapted to receive said timer therein, and a compartment at a bottom end with female threads therein, said box being covered with a lid and said knob and secured with fasteners, a lower portion of said trough immediate above said compartment transversely extending an exhale while further down said trough extending a transverse inhale interconnecting with said compartment, a ridge being provided between said trough and said compartment, underneath said exhale and above said inhale;
said linking rod being placed within said trough of said pipe, and comprising an enlarged section having a release valve at a lower end and O-rings being located above said enlarged section of said linking rod;
said plunger comprising male threads at an upper end to be threaded with said female threads of said compartment of said trough of said pipe, and having a spring sleeved from the upper end thereof;
thus when said enlarged section being urged by said spring to move upwardly, said release valve being brought to move upwardly as well and engaging with said ridge to seal a passage between said trough and said compartment.
